(19) United States
(12) Patent Application Publication
(10) Pub. No.: US 2024/0111498 A1
(43) Pub. Date: Apr. 4, 2024

(54) Apparatus, Device, Method and Computer Program for Generating Code using an LLM

(71) Applicant: Intel Corporation, Santa Clara, CA (US)

(72) Inventor: Robert VAUGHN, Portland, OR (US)

(21) Appl. No.: 18/536,299

(22) Filed: Dec. 12, 2023

(51) Int. Cl. G06F 8/33

(52) U.S. Cl. CPC G06F 8/33

(57) ABSTRACT

Examples relate to an apparatus, device, method and computer program for generating code. The apparatus is to obtain information on an existing application architecture of a modular application, the information on the existing application architecture comprising, for components of the existing architecture, a formal description of the functionality and usage of the component of the existing architecture, obtain a prompt of a user for generating code for implementing an additional component for the modular application, the prompt comprising a textual description of a desired functionality of the additional component, provide the information on the existing application architecture and the prompt as input for a Large Language Model (LLM), obtain an output of the LLM, the output comprising a portion of the code for implementing the additional component, and provide the code for implementing the additional component based on the output of the LLM.

### BACKGROUND

ChatGPT, GitHub Copilot, etc. have made the job of software developers easier. However, the generated code is still based on how a human would design the software. For example, modern applications might be considered as modular or layered with APIs (Application Programming Interfaces) that facilitate communication between various parts of the system.

The future will likely involve many applications being “prompt architected”. This will be useful for getting more applications up and running more quickly. However, generative code systems will continue to rely on legacy methods of architecting those applications including the inherit bottlenecks. One such bottleneck is with API endpoint construction. The user-developer or generative AI (Artificial Intelligence) agent will still need to understand what data can be asked of the system and how to ask the system for that data. In simple applications this is not an issue. However, as applications increase in the quantity of connected modules and connected layers then, just as is the case today, architecting new functionality or changing existing functionality becomes very difficult. For example, existing “spawning and looping” Artificial Intelligence agents like Auto-GPT lack in collaborative orchestration. The challenge with introducing new application features into a complex software system is with having either a developer or a coding system having to find out what APIs to use and how to use them or what new APIs new to be created.

### BRIEF DESCRIPTION OF THE FIGURES

Some examples of apparatuses and/or methods will be described in the following by way of example only, and with reference to the accompanying FIGURES, in which:

FIG. 1a shows a block diagram of an example of an apparatus or device for generating code, and of a computer system comprising such an apparatus or device;

FIG. 1b shows a flow diagram of an example of a method for generating code;

FIG. 2 shows a diagram of a high-level architecture of a system;

FIG. 3 shows a diagram of an example of a modular architecture;

FIGS. 4a and 4b show examples of a mockup website;

FIG. 5 shows a flow diagram of generating code based on a Large Language Model (LLM) Retrieval-Augmented Generation (RAG);

FIG. 6 shows a diagram of an example of a setup phase of the proposed concept;

FIG. 7 shows a diagram of an example of a conversion from project assets to meta-annotated data;

FIG. 8 shows a simplified example of a meta-annotated data structure;

FIG. 9 shows another example of meta-annotations in RAG;

FIG. 10 shows an example of how to create a prompt that uses the user-developed question and chunks of code and data values as input;

FIG. 11 shows how to create a prompt that uses the list of outputs from a prior operation to then refine and prioritize the scope from an LLM;

FIG. 12 shows a high-level view of the collection and processing of unstructured data into meta-annotations; and

FIG. 13 shows an example of how the proposed system works.

### DETAILED DESCRIPTION

Some examples are now described in more detail with reference to the enclosed FIGURES. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the FIGURES same or similar reference numerals refer to same or similar elements and/or features, which may be identical or implemented in a modified form while providing the same or a similar function. The thickness of lines, layers and/or areas in the FIGURES may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

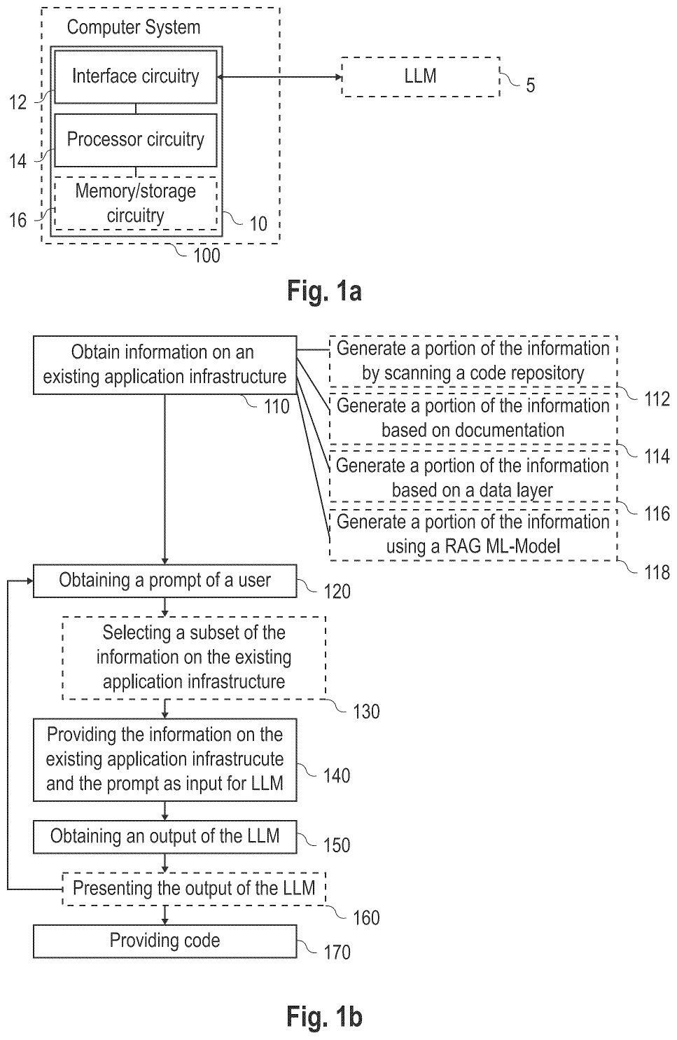

FIG. 1a shows a block diagram of an example of an apparatus 10 or device 10 for generating code, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computer system 100), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

The processor circuitry 14 or means for processing 14 is to obtain information on an existing application architecture of a modular application. The information on the existing application architecture comprises, for components of the existing architecture, a formal description of the functionality and usage of the component of the existing architecture. The processor circuitry 14 or means for processing 14 is to obtain a prompt of a user for generating code for implementing an additional component for the modular application. The prompt comprises a textual description of a desired functionality of the additional component. The processor circuitry 14 or means for processing 14 is to provide the information on the existing application architecture and the prompt as input for a Large Language Model (LLM) 5. The processor circuitry 14 or means for processing 14 is to obtain an output of the LLM. The output comprises a portion of the code for implementing the additional component. The processor circuitry 14 or means for processing 14 is to provide the code for implementing the additional component based on the output of the LLM.

FIG. 1b shows a flow diagram of an example of a corresponding method for generating code. The method comprises obtaining 110 the information on the existing application architecture of the modular application. The method comprises obtaining 120 the prompt of the user for generating code for implementing an additional component for the modular application. The method comprises providing 140 the information on the existing application architecture and the prompt as input for the LLM. The method comprises obtaining 150 the output of the LLM. The method comprises providing 160 the code for implementing the additional component based on the output of the LLM.

In the following, the functionality of the apparatus 10, device 10, computer system 100, and of the corresponding method and a corresponding computer program will be introduced in more detail with respect to the apparatus 10 and computer system 100. Features introduced in connection with the apparatus 10 and computer system 100 may likewise be included in the corresponding device 10, method and computer program.

Various examples of the present disclosure are based on the finding, that, while code generation with the help of an LLM is possible, it is mostly useful for small, self-contained programs or isolated functionality. The use of LLMs for the purpose of developing new functionality in an existing software-program is mostly limited to improved code-completion, and unsuitable for quasi-autonomous development of new software functionality, such as additional APIs in a modular application comprising a number of APIs. The main reason for the unsuitability of LLMs for this purpose is the lack of context—in general, LLMs “start from scratch”, with the user-developer providing the prompt for the LLM having to describe the prerequisites of the present project. In complex, modular software projects, this task is both complex and tedious, and will, in most cases, lead to a sub-optimal outcome, as the user-developer is likely unable to formulate the pre-requisites of a complex modular software project in a concise and consistent manner.

Some development-focused LLMs do not respond to prompts in isolation, but also take some modicum of context as input, such as the code of the function the user-developer is currently working on. However, this amount of context is unsuitable for the generation of new functionality in a modular software application. A modular (software) application is a system designed with a collection of distinct and interchangeable components, denoted modules, that can be independently developed, tested, deployed, and updated. Each module in a modular application typically encapsulates a specific piece of functionality or a set of related functions. In modular applications, each module is focused on a single aspect of the application's functionality. APIs, or Application Programming Interfaces, are crucial in modular applications. They enable modules to communicate and interact with each other without having to share the same codebase or internal knowledge of other modules. For example, APIs may be used for inter-module communication, where the APIs define a set of rules and contracts for how modules should interact. Modules use these APIs to send and receive data or commands to other modules. APIs are also used for integration with external services, abstraction, and replaceability of individual modules. APIs play a fundamental role in allowing the independent modules of the modular application to work together seamlessly.

As these modules are independent of each other and accessed only via APIs, the context of the modular application is hard to define. Additionally, as some APIs are provided externally, they may appear as a black-box towards the modular application. In this setting, providing the required context for a LLM to provide suitable code is not straightforward.

In LLM-driven software development, the Retrieval-Augmented Generation (RAG) framework is being used to improve code generation with the help of context about the application. Retrieval-augmented generation (RAG) is a framework used for integrating the dense retrieval of information with sequence-to-sequence models, such as LLMs, for natural language processing tasks, such as question answering, text completion, or conversational agents. RAG comprises two main components—the retriever, and the generator. The retriever component is responsible for obtaining relevant context or evidence from a corpus that can be helpful in generating a response. Unlike the above-mentioned manual approach, RAG can automatically fetch relevant information from a large dataset. The retrieved information is then passed to the generator, which is typically a sequence-to-sequence model, such as an LLM. The generator combines the input query with the retrieved information to produce coherent and contextually relevant answers or text.

However, RAG approaches generally rely on unstructured data, such as text documents, which are then retrieved by the retriever component. Similar to the above-mentioned difficulty for the user-developer to craft a prompt with all relevant information, the standard RAG approach is less than ideal for the development of software in modular applications, as the relationship between modules cannot be adequately modeled by the retriever model and the use of code is insufficient for the purpose of understanding the relationship.

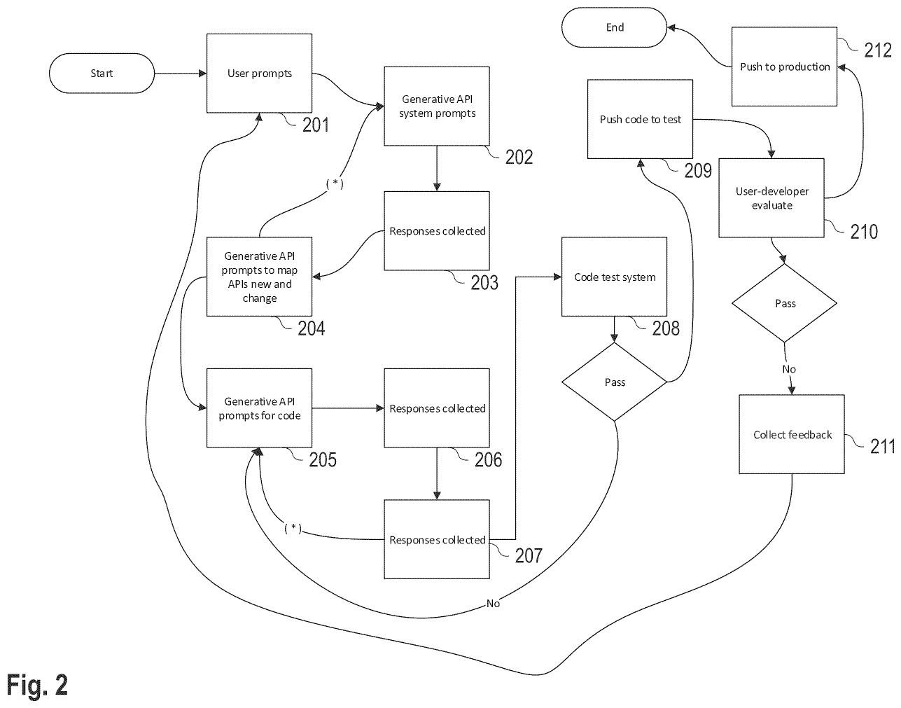

In the proposed concept, this drawback is addressed by introducing a pre-processing task, in which the existing application architecture is described, using a structured document structure (denoted MAD, meta-annotated data in connection with FIGS. 2 to 13), in a structured manner. The process starts with obtaining the information on the existing application architecture of a modular application. This information on the existing application architecture comprises, for the components of the existing architecture, a formal description of the functionality and usage of the component of the existing architecture. This formal description of the functionality and usage of the component of the existing architecture enables the definition of sufficient context to be used as input to the LLM model. For example, the formal description may comprise a key-value-based description of the functionality and usage of the component. For example, the information on the existing application architecture may comprise, as formal description, metadata on the components of the existing application architecture, e.g., a structure definition about the respective components. For example, the formal description may be defined according to a specified format, e.g., in the JavaScript Object Notation (JSON), the eXtensible Markup Language, or other tagged formats.

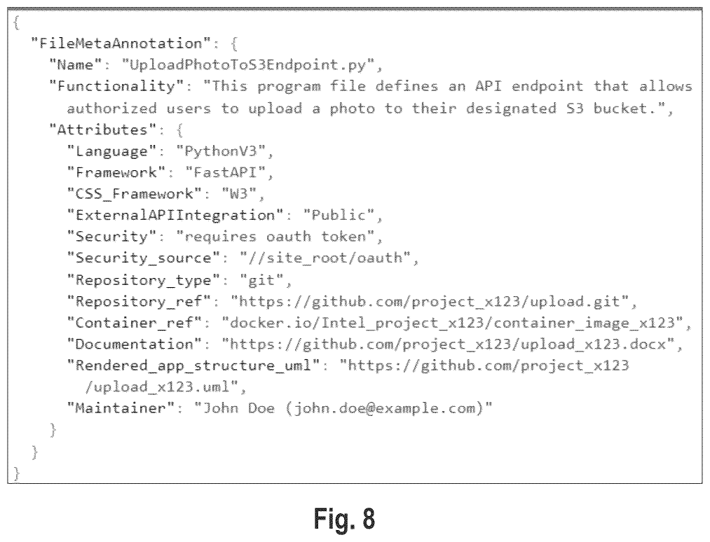

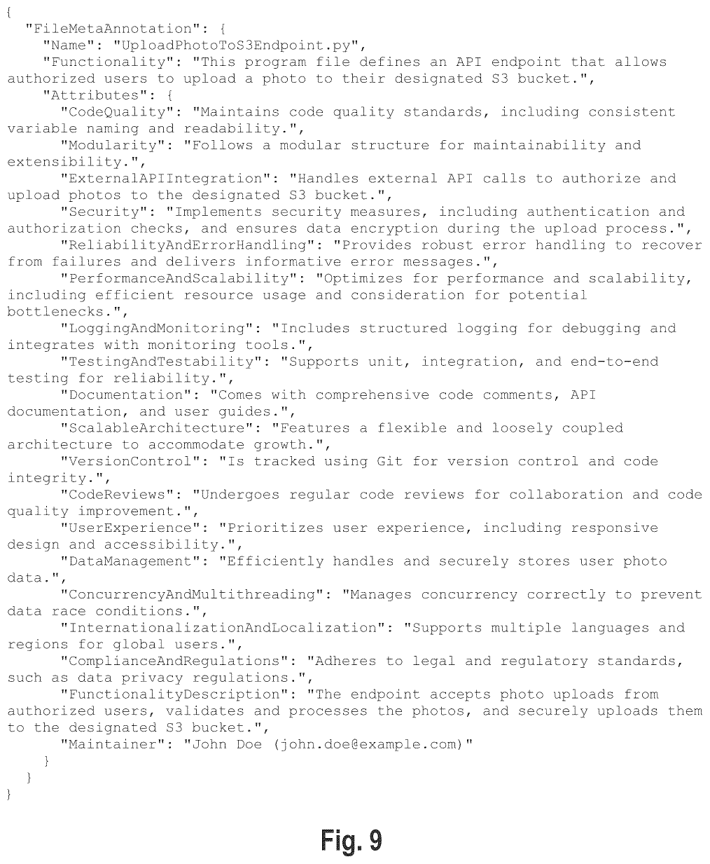

FIGS. 8 and 9 show two examples of MAD representations of components of a modular application. The MAD facilitates the structuring and standardizing of information presented to the LLM via RAG and thereby reducing the randomness or “temperature” of the responses from the LLM. “Super MADs” (i.e., comprehensive of all MAD fields across the system) can be provided as a preamble to a LLM RAG session (i.e., as input/context for the LLM) or MAD data can be selectively provided during a LLM RAG session (as input/context for the LLM) or a hybrid model may be utilized where a LLM RAG session (at the LLM) is initiated with a set of “system wide” MAD fields and subsequent queries within the LLM RAG session may be provided with selective MAD fields. As can be seen from these FIGURES, a wide range of different attributes or properties of the respective components may be included in the information on the existing application architecture. For example, the information on the existing application architecture may comprise, for the respective components of the existing application architecture, at least one of information of a functionality of the component (e.g., a textual description of its functionality), information on a usage of the component (e.g., a textual description of how the component is used, a reference to other component(s) using the component, parameters for using the component etc.), information on a security of the component (e.g., what security measures are used, such as authentication, cryptographic signing or encryption), information on an authentication scheme used by the component (e.g., does the component use authentication, if yes, what authentication is used, which component provides the authentication), information on a programming language being used to implement the component, information on one or more programming frameworks being used to implement the component, information on one or more libraries (or frameworks) being used by the component, information on a use of one or more external API by the component (i.e., whether the component accesses an external API, and for which purpose), information on an error handling of the component, information on a scalability of the component, information on a testability of the component, information on a user experience provided by the component, information on a data management of the component, information on an internationalization or localization of the component, information on a version control system being used for the component, information on a support for concurrency by the component, information on a code quality requirement supported by the component, and information on a name of the component (e.g., to identify or call the component). In addition to the components that are internal to the modular information, information may be provided on external APIs being available for use may be provided. An external API is offered by a third-party service or platform outside of the system, i.e., outside the modular application, that intends to use it. For example, the information on the existing application architecture may comprise information on one or more external APIs being available for use by the modular application.

To generate the information on the existing application architecture, the existing application architecture may be processed. In many cases, much of the necessary information, such as code, data model, and documentation, is stored in a repository being used for developing the modular application. For example, the processor circuitry may scan a code repository to generate at least a portion of the information on the existing application architecture. Accordingly, as further shown in FIG. 1b, the method may comprise scanning the code repository to generate 112 at least a portion of the information on the existing application architecture.

In addition to the source code being stored in the code repository, also the data model and the documentation may be processed to generate the information the existing application architecture. For example, the processor circuitry may generate at least a portion of the information on the existing application architecture based on a documentation of the existing application architecture being stored in the code repository. Accordingly, the method may comprise generating 114 at least a portion of the information on the existing application architecture based on a documentation of the existing application architecture being stored in the code repository. For example, the documentation of the existing application architecture may comprise one or more of requirement documentation, design documentation, API documentation, code comments, explanations of algorithms, and testing documentation.

The data model or data layer of the modular application is also of interest for the purpose of generating additional functionality. A data model of an application is an abstract model that organizes and defines how data is stored, managed, and used within a software application, such as the modular application. A data layer is an abstraction level within the modular application, which may be provided by one or more components/modules of the modular application, that handles the management of data. It is responsible for data storage, retrieval, and manipulation, ensuring that data is consistently served to other parts of the modular application. The processor circuitry may generate at least a portion of the information on the existing application architecture based on the data layer or data model of the existing application architecture. Accordingly, as shown in FIG. 1b, the method may comprise generating 116 at least a portion of the information on the existing application architecture based on a data layer of the existing application architecture.

While the use of a RAG framework, in isolation, may be less suitable for generating the new functionality, a retriever component of a RAG framework may be used to compile at least some of the information that is included in the information on the existing application architecture. For example, the formal description may be at least partially based on information provided by a retriever model. For example, the retriever model may compile information from documentation for inclusion in the information on the existing application architecture. For example, the processor circuitry may generate at least a portion of the information on the existing application architecture using a Retrieval-Augmented Generation machine-learning model. Accordingly, as shown in FIG. 1b, the method may comprise generating 118 at least a portion of the information on the existing application architecture using a Retrieval-Augmented Generation machine-learning model.

In addition to the information on the existing application architecture, which is provided as context for the LLM, the prompt of the user is provided to the LLM as input. This prompt is first obtained from the user-developer. The prompt comprises a textual description of a desired functionality of the additional component. For example, the textual description may comprise a natural language description of the desired functionality of the additional component. Alternatively, the prompt may comprise a coded description, such as a mockup, of the desired functionality. For example, the prompt may describe or show what additional functionality is to be added to the modular application. In particular, the prompt may describe a textual description of an API that is to be added to the modular application. In other words, the additional component may be an API being provided as part of the modular application. However, the scope of the proposed concept is not limited to a single API—in some cases, to provide an additional functionality, one or more helper APIs may be defined as further additional components being used by the additional component for providing the desired functionality.

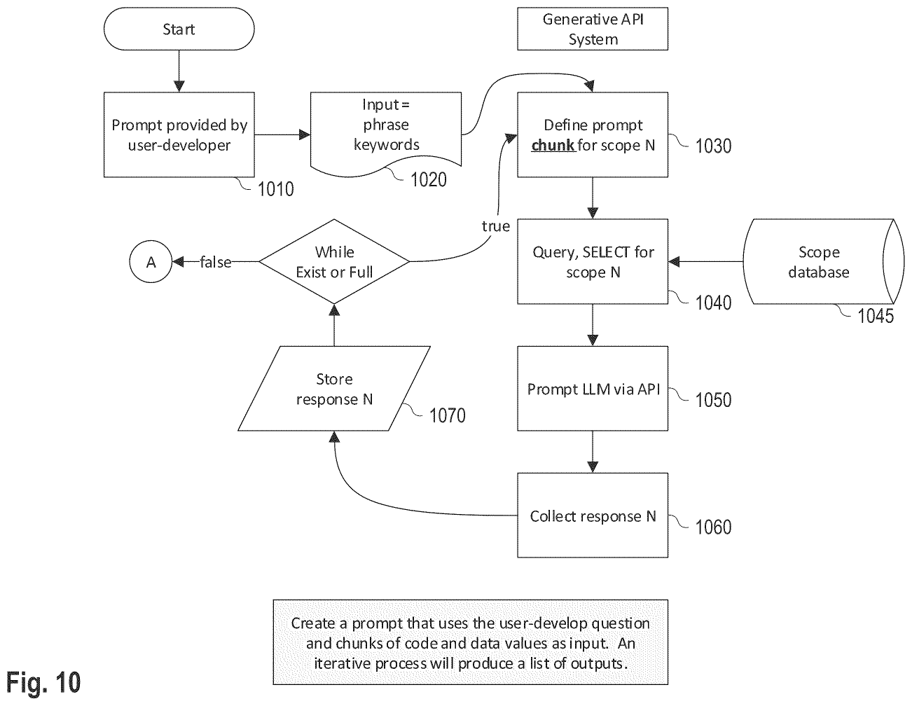

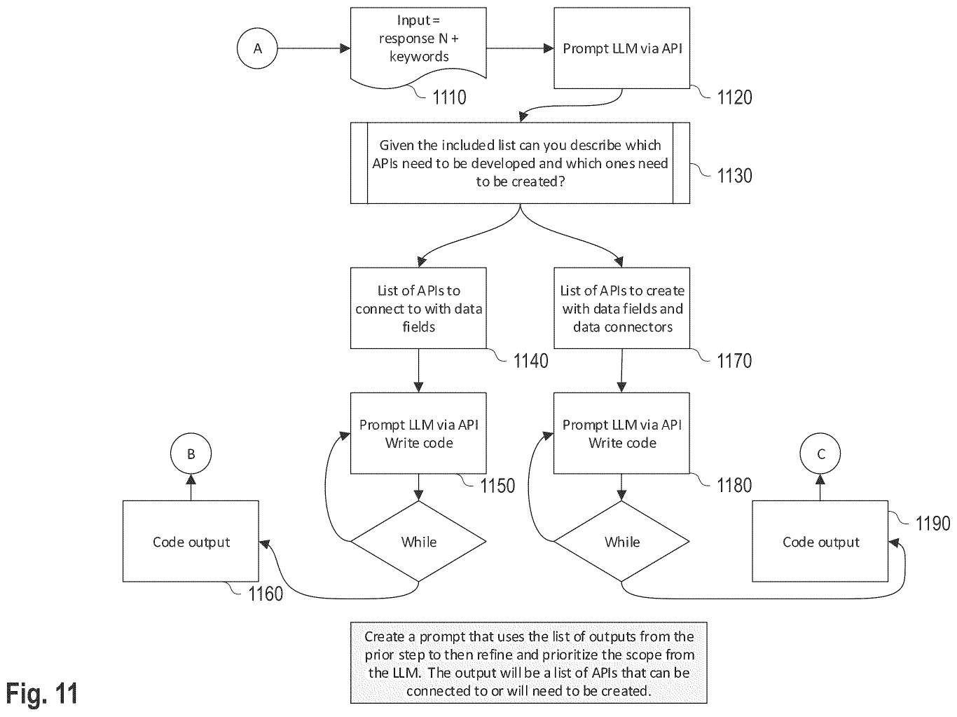

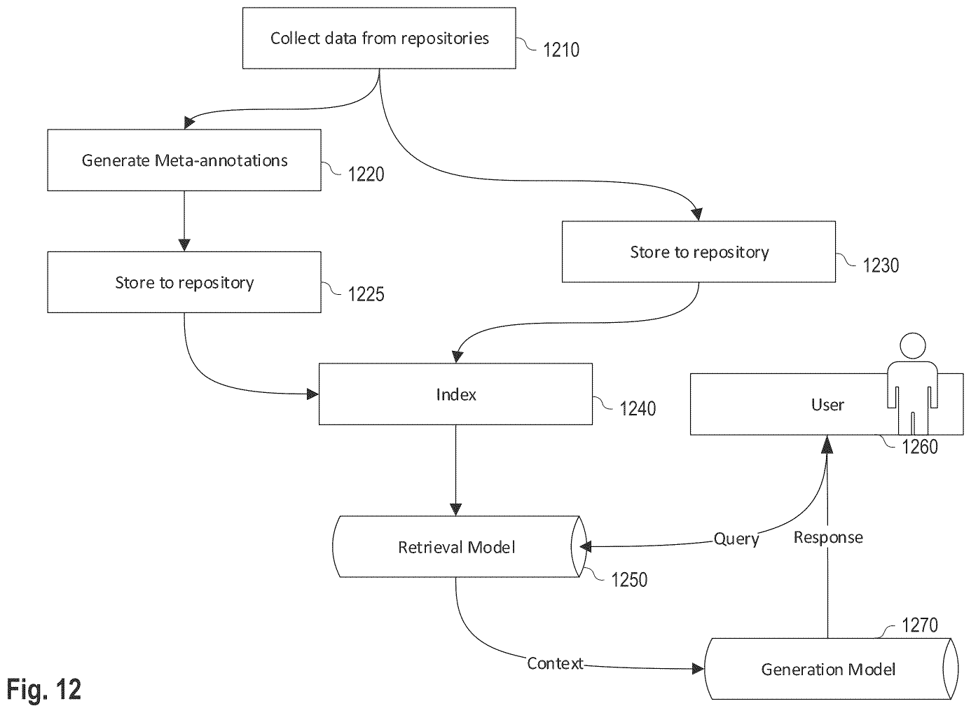

FIGS. 10 to 13 provide an example flow of how a prompt and the information on the existing application architecture can be used to generate the desired code. In FIG. 10, a flow is shown, in which an iterative approach is used to sub-divide the desired functionality into chunks (e.g., starting from a high-level abstraction, and separating the different aspects into different chunks having different scopes), with the information on the existing application architecture being provided as context to the query 1040 from a scope database. In FIG. 11, the respective chunks are then processed separately or together, to determine which existing API(s) is/are to be used and additional API(s) is/are to be created. Once lists of APIs have been created, the corresponding code for the APIs is generated. In FIG. 12, the generation of the information on the existing application architecture is shown, which is stored in index 1240, and then used by retrieval model 1250 to provide the context for the generation model 1270 for the prompts provided by the user 1260.

The processor circuitry provides the information on the existing application architecture and the prompt as input for the LLM. Large Language Models are a type of AI that have been trained on vast amounts of text data. They are designed to generate text that is contextually relevant and grammatically correct. These models use deep learning techniques and are often based on architectures such as Transformer networks. In the present context, the LLM is primarily used to generate code and proposals for additional components (such as APIs). Accordingly, the LLM may be at least partially trained based on (source) code. However, the LLM might not be trained on the specific modular application at hand. On the contrary, by providing the information on the existing application architecture as context for the LLM, a generic LLM may be used that is not fine-tuned to the modular application at hand. For example, a generic code-generation or conversational LLM may be used. In other words, the LLM may be a text-generation LLM capable of generating code or a code-generation LLM. For example, the LLM may be provided by a third-party and be accessible via an API. In other words, the information on the existing application architecture and the prompt may be provided as input to the LLM via an API of an external service for accessing the LLM. Alternatively, an on-premises LLM may be used. For example, the LLM may be the “Generator” component of the RAG system discussed above.

In some cases, the existing application architecture of the modular application may be so large, that the LLM cannot process all of the information as context. Moreover, to implement some additional functionality, not all of the existing component of the existing application architecture may be of relevance. Therefore, depending on the prompt, only a subset (e.g., a part) of the information on the existing application architecture may be provided as context for the LLM. In other words, the processor circuitry may select, based on the prompt of the user, a subset of the information on the existing application architecture, and provide the subset of the information on the existing application architecture as input for the LLM. Accordingly, as shown in FIG. 1b, the method may comprise selecting 130, based on the prompt of the user, a subset of the information on the existing application architecture, and providing 140 the subset of the information on the existing application architecture as input for the LLM. For example, the selection may be based on an output of the “Retriever” component of the RAG system.

The processor circuitry may then obtain an output of the LLM, with the output comprising a portion of the code for implementing the additional component. However, initially, the output may comprise additional questions of the LLM, or the code provided by the LLM may be unsuitable for the task at hand. Moreover, to implement complex tasks, the output may comprise code for the desired functionality, but lack code for one or more further components being additionally required for providing the functionality. For this reason, at this point, the user-developer may be involved in refining the prompt and providing follow-up prompts, asking the LLM to adjust the output or provide code for additional components or aspects. For example, the processor circuitry may present the output of the LLM to the user. Accordingly, as shown in FIG. 1b, the method may comprise presenting 160 the output of the LLM to the user. The user may then determine whether the provided code is sufficient. If not, the user may refine the prompt or ask a follow-up prompt. In other words, the processor circuitry may obtain a refined prompt or follow-up prompt after presenting the output of the LLM to the user and provide at least the refined prompt or follow-up prompt as input to the LLM. Depending on the implementation of the LLM, the information on the existing application architecture may be provided again or remain present inside the LLM's internal state. In some cases, the scope of the information on the existing application architecture (i.e., the subset being provided) may be adjusted based on the refined or follow-up prompt. The processor circuitry may then obtain a further output of the LLM, and (eventually) provide the code for implementing the additional component based on the further output of the LLM. This process may be repeated until the user is satisfied with the resulting code. In other words, the processor circuitry may iteratively repeat the operations of presenting the output of the LLM to the user, obtaining the refined prompt or follow-up prompt, providing at least the refined prompt or follow-up prompt as input to the LLM, obtaining the further output of the LLM, and providing the code for implementing the additional component based on the further output of the LLM, e.g., until the user terminates the iterative process. Additionally, the iterative process may be repeated until the generated code successfully compiles on a testing platform. The resulting code for implementing the additional component is then provided based on the output of the LLM, e.g., stored in one or more source code files, uploaded into a repository (e.g., as source code or pull request), or output via a HTML (HyperText Markup Language) document.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information. For example, the interface circuitry may comprise a modem for communicating via an access network of an ISP.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the apparatus 10, device 10, computer system 100, method and computer program are mentioned in connection with the proposed concept, or one or more examples described above or below (e.g., FIGS. 2 to 13). The apparatus 10, device 10, computer system 100, method and computer program may comprise one or more additional optional features corresponding to one or more aspects of the proposed concept, or one or more examples described above or below.

Various examples of the present disclosure relate to a concept for dynamically generated layered APIs using collaborative LLM.

The present disclosure discusses methods to fully automate APIs in complex software architecture. The present disclosure addresses several key challenges in leveraging AI (LLM) to generate code for new feature introduction. In particular, the present disclosure is based on the finding, that fine-tuning of an AI model for complex software systems is a bottleneck. The proposed concept introduces methods to leverage general-purpose Ais, and in particular Large Language Models (LLMs), to develop complex software changes with a general-purpose AI. It does not require fine-tuning, as fine-tuning may be viewed as a roadblock to fast development. Instead, a general-purpose LLM may be used. Moreover, the present disclosure acknowledges that discovering APIs and identifying missing APIs for new functionality is a complex process, which is addressed by various examples of the present disclosure.

In general, there are many examples of automated or simplified methods of building a form on top of a data layer. Desktop database software, such as Microsoft Access, is one example. Moreover, low code and no code systems such as OutSystems can generate forms based on a data model. All of those systems require direct access to the data model and lack advanced intelligence in being able to collaboratively work with the user-developer to provide the necessary code.

In a complex software system, the user-developer who intends to make a change or addition to the software system may provide a description, such as example output or a mock-up, that can be used by a generative AI agent embedded within a system to iterate through available APIs to produce the desired output. The desired output is code generated that produces the results expected by the user-developer. The user-developer who intends to make a change or addition to the software system does not necessarily need to have any understanding of the underlying architectural structure of the system. The system does not need to provide pre-defined configurable forms. While those are easy for the user-developer to interact with to introduce new functionality, they consume time and effort from the system architect to envision as many possible scenarios.

In particular, the topic of updating complex modular software applications can be a challenge. Not all developers have deep knowledge of an application's architecture. It takes time to get a thorough understanding of an application even with good documentation and the programming having descriptive variable/function naming. It gets even more complicated when considering testing, security, operational and scaling considerations. The present disclosure is based on the insight that LLMs can generate code based on a prompt and is aware that LLMs can leverage RAG to review project code and documentation and can be prompted to generate new code. The present disclosure is also aware of the concept of “prompt engineering” for influencing a desired result.

The challenges addressed by various examples of the present disclosure are based on the finding that IT (Information Technology) is a bottleneck. While this statement is rather generalized, to a great extent, IT is significantly challenged to deliver updated and new functionality for apps. The challenge is that humans need to conceptualize a system (i.e., wrap their head around it) in order to make changes or introduce new capabilities. There are tools. (i.e., Static Code Analysis, API Specification Files, etc.) but all of these tools only address specific parts of the application and implementation requirements. The aforementioned LLM methods are insufficient for this purpose.

For example, in many cases, the use of LLM AI in code development faces the following challenges. For example, one course of action is to take everything (all the program files, documentation, etc.) and finetune an LLM, followed by asking questions about the application. However, this may be considered infeasible because of the cost and delays introduced through finetuning. Another course of action is to have the programmer “conceptualize” enough of the app to then ask a question of a code-generating LLM. While this may provide some benefit, the ramp time for a developer can be significant. A third course of action is to use a LLM coupled with Retrieval Augmented Generation (RAG). However, this brings about new challenges. RAG models, used in this scope, can easily present problems related to context, quality, security, dependencies, and in particular problems related to consistency of style and architecture. Finally, LLMs are not “naturally” integrated into the software development lifecycle (SDLC).

The proposed concept makes use of existing AI models, patterns, RAG, etc., while improving upon these concepts in the context of application development by addressing challenges related to the aforementioned context, quality, security, dependencies, etc. when integrated into SDLC practices. The proposed concept integrates into every stage of the SDLC. It collaborates with stakeholders, including discovering who they are, throughout the entire process. Therefore, this proposed concept is more about automation (i.e., RPA, Robotic Process Automation) scoped to app development than it is an AI proposed concept.

One of the particular challenges the proposed concept addresses relates to increasing the reliability and consistency of generated architectural assets (code, APIs, etc.). Due to the stochastic nature of generation, even with careful prompt engineering, the assets (code, documentation, messages, etc.) are subject to variable level of randomness in query responses. Along with integrating into the SDLC, the proposed concept introduces a method to reduce the temperature of a pre-trained LLM and hold that temperature across team interactions.

The proposed concept is based on the finding, that, by adding a structure to every file (i.e., program files, documentation, etc.), the quality can be improved (thus reducing the temperature consistently). To that end, a capability is used in the proposed concept that adds structure to any document. In the following, this structed is denoted a meta-annotation. For example, FIGS. 8 and 9 give examples for meta-annotations. This aspect does not relate to prompt engineering, but rather provides a new layer on RAG. The proposed concept thus provides methods to enforce consistency in architecture and code to increase quality with meta-annotations in RAG. The proposed concept relates to how the system ties every stage of the SDLC together to accelerate code development, and to how the proposed concept collaborates with both users and code/document repositories.

To support modular programs there will likely be many APIs. Changing the system may thus involve creating new APIs, understanding old APIs and figuring out integration of those new APIs.

FIG. 2 shows a diagram of a high-level architecture of the proposed system and process. After starting the process, at 201, the user supplies a prompt, which is provided as generative AI (e.g., LLM) system prompt at 202. At 203, the responses of the generative AI are collected. At 204, a generative AI prompt is generated to map APIs new and change, which may be used to refine the generative API system prompts at 202. At 205, a generative AI prompt for code is generated. At 206 and 207, the responses are collected, which may be used to refine the generative API prompts for code at 205. In addition, or after refinement, the generated code may be provided to a code test system 208. If the code passes the code test, at 209, the code is pushed to test, if not, at 205, the generative AI prompt for code is refined. At 210, the user-developer evaluates the code. If the code fails the evaluation by the user-developer, at 211, feedback is collected, and at 201, the initial user prompt is refined. If the code passes the evaluation by the user developer, at 212, the code is pushed to production, and the process ends.

In the following, a motivation behind this process is illustrated using a simple example of multiple APIs communicating with each other in an e-commerce system. For example, in an e-commerce system, a frontend application sends a request to a product catalog API to retrieve product information for display on the website. The product catalog API receives the request and sends a request to an inventory management API to get the stock levels for each product. The inventory management API retrieves the stock levels from a database and sends the response back to the product catalog API. The product catalog API combines the product information with the stock levels and sends the final response back to the frontend application. When a customer places an order on the website, the frontend application sends a request to an order management API to create a new order. The order management API receives the request and sends a request to a payment gateway API to process the payment. The payment gateway API communicates with the payment processor and sends a response back to the order management API indicating whether the payment was successful or not. If the payment was successful, the order management API creates a new order in the database and sends a confirmation email to the customer. The frontend application displays a confirmation message to the customer, indicating that their order was successfully processed.

The preceding system will evolve. For example, a function is to be added that allows user-developers to upload images to the platform. A new API endpoint can be created that receives image files from the user-developer and saves them to a storage service. Other APIs in the system, such as the user-developer profile API, can then access these images to display them to other user-developers or perform other functions. The image upload API can also communicate with other APIs, such as a moderation API that checks uploaded images for inappropriate content before they are displayed on the platform.

Integrating a new function is complicated. For example, integrating a photo upload function may require modifying or creating APIs that handle image uploads. Depending on the specifics of the system, the following APIs may need to be modified or created. For example, an authentication API may be modified. The photo upload API may require authentication to ensure that only authorized user-developers can upload photos. In this case, the authentication API may be modified to allow for the authentication of photo upload requests. For example, a photo upload API may be created. A new API would need to be created that accepts image files and stores them on the server. The API would need to handle file validation, resizing, and storage. For example, a storage API may be modified. The photo upload API would need to communicate with a storage API that handles the actual storage of the image files. The storage API would need to be modified to allow for the storage of image files and the retrieval of image URLs. For example, a photo retrieval API may be created. A new API would need to be created that allows user-developers to retrieve uploaded photos. The API would need to handle image resizing and the retrieval of image URLs (Uniform Resource Locators) from the storage API. In terms of API endpoint/request development, the documentation for each of these APIs would need to be understood in order to properly format requests for image uploads and retrievals. Additionally, any necessary authentication tokens or API keys would need to be obtained and included in the requests. In the above example, the level of complexity of the development of APIs is illustrated, regardless of whether the coding is done “manually” or with something like ChatGPT.

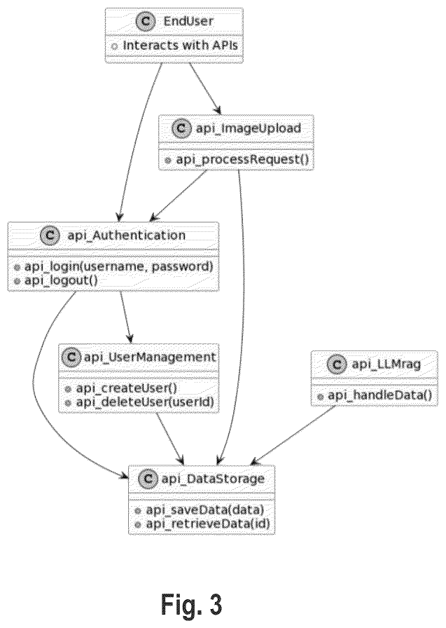

FIG. 3 shows a diagram of an example of a modular architecture, with an end user using the authentication API and the image upload API, the image upload API using the authentication API, the authentication API using a user management API and a data storage API, and an LLM RAG AI also accessing the data storage API. The above example shows that modular applications are stitched together with APIs. This results in a challenge for developers to introduce new features and to debug. A particular challenge is in conceptualizing architecture and dependencies.

In the following, a simpler scenario of an API system with four layers is illustrated. The API system comprises a client layer: This is the layer that the end user-developer interacts with. In our example, this could be a mobile app or a web application for an ecommerce store. The API system comprises an application layer: This layer contains the business logic and is responsible for processing the user-developer requests. It communicates with the client layer via APIs and with the data layer via APIs as well. The API system comprises a data layer: This layer contains the databases and data storage systems where the ecommerce store's data is stored. It communicates with the application layer via APIs. The API system comprises a third-party layer: This layer consists of any third-party services or APIs that the ecommerce store relies on. For example, the store may use a payment processing API or a shipping API. These third-party services communicate with the application layer via APIs.

In this system, the client layer sends API requests to the application layer, which processes the requests and sends API requests to the data layer to retrieve or update data. The application layer may also send API requests to third-party services to perform tasks like payment processing or shipping. The data layer and third-party services respond to the API requests with data or status updates, which are then sent back to the application layer and ultimately to the client layer.

To add one more function at the client layer will require the application layer to have a new API. Assuming a new feature is to be added to the e-commerce system that allows customers to view their order history. In this case, a new API endpoint may be created in the application layer that can retrieve order history data from the database layer. This new API would then need to be documented and made available to the client layer so that it can be called by the front-end application to display the order history to the customer. Once the new API is in place, the client layer can make requests to it to retrieve order history data and display it to the customer.

If the developer were to prompt an LLM with a question like such as “How do I add a new feature to our e-commerce system that allows customers to view their order history? I am using Python Django”. The first stage that the LLM may include might be something like, “Define the API endpoint: Define a new API endpoint on the backend that allows user-developers to retrieve their order history. This API endpoint should accept an authentication token and return the list of orders associated with the authenticated user-developer.” So, even if the developer “prompt engineers” their way through the application upgrade, a human or advanced generative AI agent may have to map out and define the new API endpoint.

In the proposed concept, with respect to this simplified scenario, and recognizing that most new functions will be driven from the app owner, it may be reasonable to assume that the app owner would prefer to create the new function from the GUI (Graphical User Interface). However, the starting point for a change may start at a different “layer” of the application or from a simple description. The following example is used to provide some context for one of the many possible uses of the proposed concept.

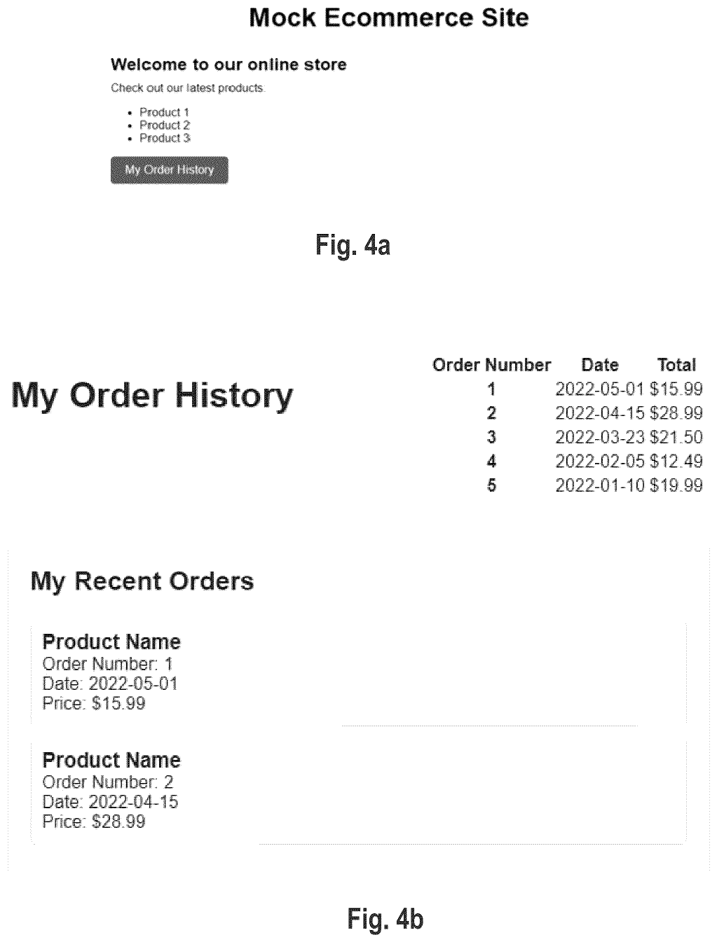

The app owner who is creating the new function may generate a GUI based form for “Order History”. The app owner may code this themselves, use a generative AI agent or have actual programmers create the coding. In this example, at stage 1, a web form is created. Creating a web form (in Django or other platforms) is well-known and can be done as a starting point for the user-developer. FIGS. 4a and 4b show examples of a mockup website. In FIG. 4a, it is shown that a “My Order History” button has been added. In FIG. 4b, the app owner (i.e., user-developer) has created a mock-up of “My Order History”. So far, these web forms are easy to generate. The backend functionality is the challenge. The user-developer has essentially created a button on one web page and an expected mock-up of results. Both are easy to do (as mock-up) and can also be described in other manners. The challenge is with having a coding system determine what the user-developer wants and then generating code. Key to that process is in determining what APIs to use and how to use them.

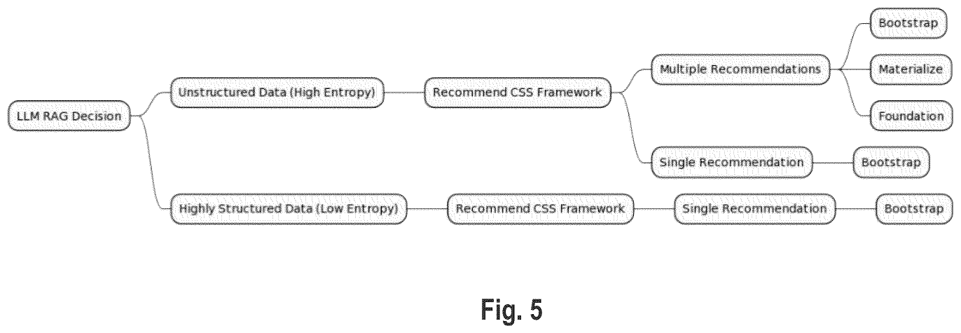

While code generation using LLMs is a known concept, LLMs do not know your application, and LLM fine tuning is too computationally expensive to keep up with fast changing software/applications. While RAG can be used to assist the LLM-based coding processing, has limited information and a high entropy/temperature, and may result in inconsistent (non-deterministic) behavior in software, which causes problems with respect to standards, architecture, etc. FIG. 5 shows a flow diagram of generating code based on an LLM RAG.

In its simplest form, the proposed concept utilizes contextual chaining to build an understanding of what the user-developer is hoping to accomplish. The proposed concept overcomes at least some of the challenges faced by LLM-based approaches by relying on meta-annotations of the existing software architecture. The proposed concept will be described, for brevity and simplicity, as a Generative API.

In some implementations the Generative API may be fully integrated into the code base. In other implementations the Generative API may be given access to APIs. In either case the Generative API may be permissioned according to the role. While in training mode, the role may be increased (like to administrator) and then downgraded for production roll out. The Generative API may be considered as a singular system that connects to many APIs or as a collection of independent systems that collaborate with each other. It is expected that the Generative API system is be used on complex software platforms that have many, perhaps tens or hundreds of APIs.

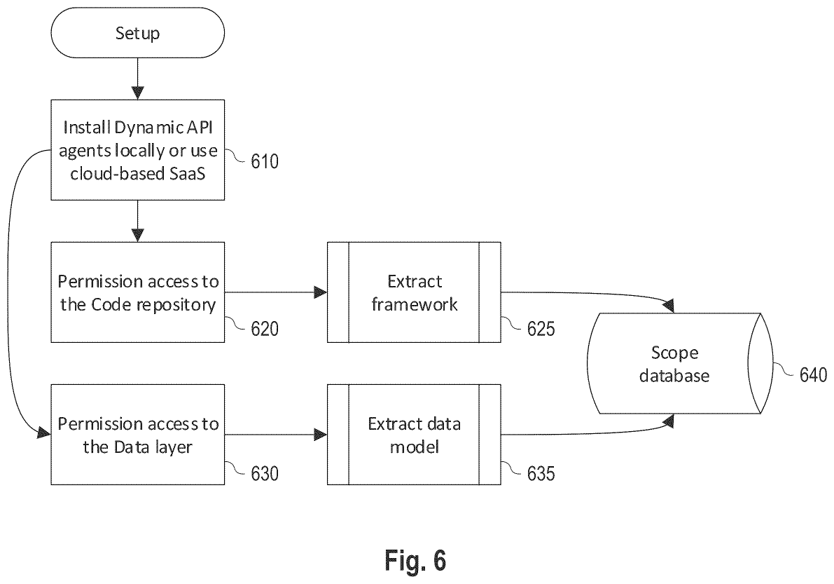

FIG. 6 shows a diagram of an example of a setup phase of the proposed concept. At 610, dynamic API agents are installed locally or a cloud-based Software-as-a-Service is used. At 620, permission is given to access the code repository, where, at 625, the framework is extracted. At 630, permission is given to access the data layer, where, at 635, the data model is extracted. At 640, both the framework and the data model are stored in a scope database. In effect, data is collected from both the code repository and the data layer and stored in the database 640.

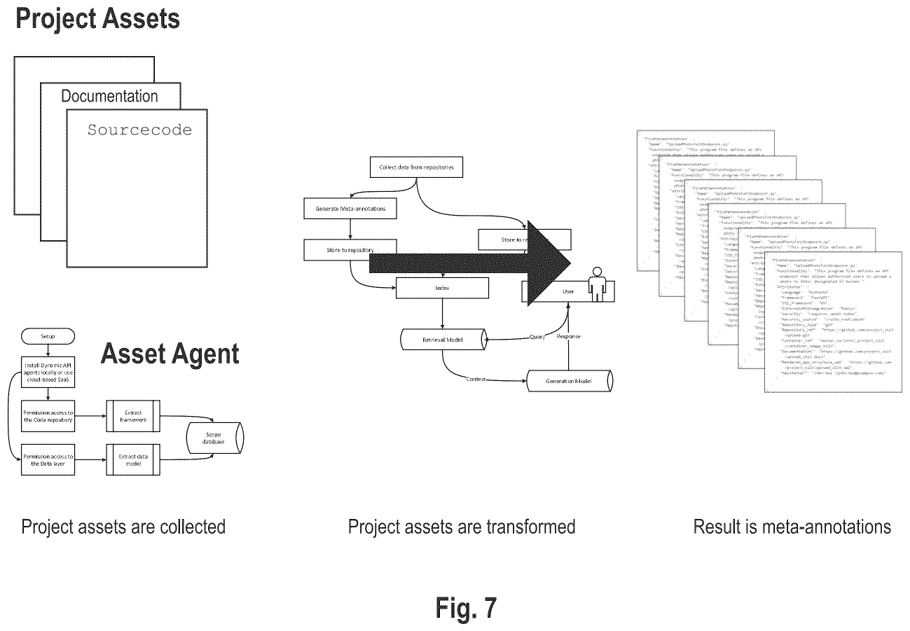

FIG. 7 shows a diagram of an example of a conversion from project assets to meta-annotated data, to reduce the temperature. Project assets, such as documentation, source code, data model etc. are collected (using the asset agent shown in FIG. 6). Then, the project assets are transformed (e.g., using the process shown in FIG. 12), resulting in meta-annotations or meta-annotated data (MAD). In the following, a closer look is provided at meta-annotated data (MAD) in RAG. In various examples of the present disclosure, every asset in a software project repository may be processed to a standard format. RAG may be constrained to MAD descriptors, and RAG output may be validated to MAD descriptors.

FIG. 8 shows a simplified example of a meta-annotated data structure. From a program file in the project repository, UploadPhotoToS3Endpoint.py, the MAD is generated. The MAD may contain properties, such as the name of the file, its functionality, and attributes, such as the programming language, framework, CSS (Cascading Style Sheet)-framework, integration of an external API, security, security source, repository type, repository reference, container reference, documentation, Unified Markup Language (UML) representation and maintainer of the file. The MAD (along with many other MADs) can help RAG in generating new functionality within the program file or as information to help build a new API. The MAD may be constructed from pre-defined software primitives like programming language, frameworks used, security methods, hardware type (i.e., Graphics Processing Unit, Central Processing Unit, etc.)

FIG. 9 shows another example of meta-annotations in RAG. Here, other/additional attributes, such as code quality, modularity, reliability and error handling, performance and scalability, logging and monitoring, testing and testability, scalable architecture, version control, code reviews, user experience, data management, concurrency and multithreading, internationalization and localization, compliance and regulations, and functionality description are shown. The meta-annotation may be developed using a specialized RAG. As data is being crawled, the original content is captured and processed for meta-annotation. The meta-annotated files are then used within the RAG to collaboratively assist in the development of code updates or new code.

When the user-developer (developer) has a need to add new functionality, the user-developer can create a mock-up of a form with the form fields. The form fields do not need to be accurate, just reasonable. Alternatively, the user-developer may simply write, “I need new functionality in the Program that will do X, Y and Z.” The user-developer provides that initial information to the LLM. An automated iterative contextual chaining process then takes place.

The system is used by the developer specifying requirements for a new API or to connect new function (calls) to an existing API. The developer prompts the LLM. The system will will generate new code for API and recommend where to land. The developer can then test/modify.

FIG. 10 shows an example of how to create a prompt that uses the user-developed question and chunks of code and data values as input. An iterative process will produce a list of outputs. The process starts at 1010 with a prompt provided by the user-developer. At 1020, the prompt is transformed into an input=phrase keywords. At 1030, in the Generative API system, a prompt chunk is defined for scope N. At 1040, a query is performed to obtain MAD data from scope database 1045 for scope N. At 1050, the LLM is prompted via an API. At 1060, a response of the LLM is collected for scope N. At 1070, the response for scope N is stored. While there are additional chunks/scopes, the process starting at 1030 is repeated. Afterwards, the process continues as defined in FIG. 11.

FIG. 11 shows how to create a prompt that uses the list of outputs from a prior operation to then refine and prioritize the scope from an LLM. At 1110, the input is the response for scope N and keywords. Using the input, at 1120, the LLM is prompted via an API, using a prompt 1130 such as “Given the included list, can you describe which APIs need to be developed and which ones need to be created”. The result of the prompt is, on the one hand, at 1140, a list of APIs to connect to with data. At 1150, the LLM is prompted via the API to write code until a stopping criterion is met, i.e., the necessary code has been provided. At 1160, the code is output. On the other hand, at 1170, the result is a list of APIs to create with data fields and data connectors. At 1180, the LLM is prompted via the API to write code until a stopping criterion is met, i.e., the necessary code has been provided. At 1190, the code is output. The output will be a list of APIs that can be connected to or will need to be created. Subsequent stages will be used to test the code, refine the output based on user feedback and finally push to production.

FIG. 12 shows a high-level view of the collection and processing of unstructured data into meta-annotations, with those meta-annotations subsequently being used in the RAG process. At 1210, data is collected from repositories. On the one hand, at 1220, from the data, meta-annotations can be generated, which are stored, at 1225, to a repository. On the other hand, at 1230, some data may be stored directly to the repository. At 1240, the data is indexed and provided to a retrieval model 1250, which is also supplied with a query/prompt 1260 by a user. The Retrieval model the provides context for the generation model 1270, which provides a response for the user.

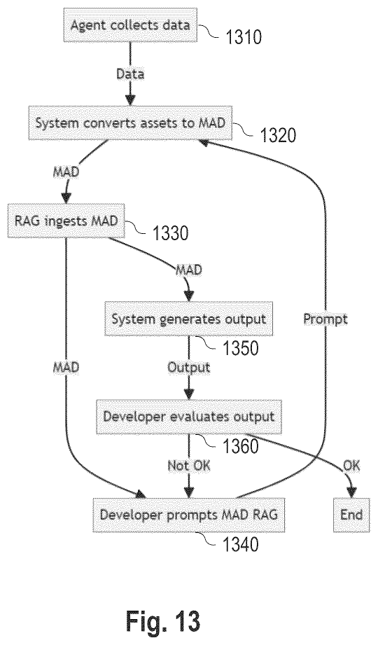

FIG. 13 shows an example of how the proposed system works. At 1310, a system agent collects the project assets (this collection occurs “live”, i.e., on current data). At 1320, a system process converts the assets to meta-annotated data structures (MADs). At 1330, the RAG system ingests and contains the MADs. At 1340, questions (prompts) from developer are processed against MAD RAGs. MAD RAG produces code, diagrams (UML) and documentation. At 1350, the system generates an output, based on the MAD provided by the RAD system. At 1360, the developer evaluates the output. If the developer is content, then the process ends. If not, the developer continues prompting the MAD RAG.

The proposed system may be always up-to-date as SW project evolves. It may be highly deterministic (i.e., have a predictive behavior). The proposed system has lightweight ingestion processing (without requiring training/fine-tuning). It may be extended to add functionality within a program. The proposed concept may decrease the time and effort required for introducing new APIs into modular software.

The proposed concept may be implemented by a DevOps (Developer Operations) team to drive implementation. Key considerations for implementation would be for the system to collaborate with an application owner (for example) to understand the location of repositories. The collaboration may be driven through a specialized RAG scoped to SDLC. These workflows may be part of the proposed concept.

The system gathers information and begins processing repository information. Part of the processing may involve 1) polling for changes, 2) indexing and 3) processing meta-annotations. At this point, the system may provide responses related to the system architecture, performance (via log analysis), etc.

The proposed concept addresses challenges related to how software engineers/developers can automate the development of modular and microservices based complex applications. Of course, LLMs (etc.) can generate code. However, there are no known methods to integrate DevOps practices and code development that span a system that is only loosely coupled. The proposed concept does not make claims to advances in AI algorithms. Existing AI technology are used as ingredients in the proposed concept to enable a new feature to automatically be mapped into the system. This is an incredibly complex process for human engineers to do. AI generated code will make life easier, but app architecture remains a challenge. In general, AI systems are unable to collaborate across the entire SDLC. That is what this proposed concept does. The proposed concept combines existing AI methods in a new context (systems architecture) with new methods of managing the input/output streams of AI data coupled with new system mapping methods.

More details and aspects of the concept for dynamically generated layered APIs using collaborative LLM are mentioned in connection with the proposed concept or one or more examples described above or below (e.g., FIG. 1a to 1b). The concept for dynamically generated layered APIs using collaborative LLM may comprise one or more additional optional features corresponding to one or more aspects of the proposed concept or one or more examples described above or below.

In the following, some examples of the proposed concept are presented:

An example (e.g., example 1) relates to an apparatus (10) for providing code, the apparatus comprising interface circuitry (12), machine-readable instructions, and processor circuitry (14) to execute the machine-readable instructions to obtain information on an existing application architecture of a modular application, the information on the existing application architecture comprising, for components of the existing architecture, a formal description of the functionality and usage of the component of the existing architecture, obtain a prompt of a user for generating code for implementing an additional component for the modular application, the prompt comprising a textual description of a desired functionality of the additional component, provide the information on the existing application architecture and the prompt as input for a Large Language Model (LLM), obtain an output of the LLM, the output comprising a portion of the code for implementing the additional component, and provide the code for implementing the additional component based on the output of the LLM.

Another example (e.g., example 2) relates to a previous example (e.g., example 1) or to any other example, further comprising that the additional component is an Application Programming Interface (API) being provided as part of the modular application.

Another example (e.g., example 3) relates to a previous example (e.g., one of the examples 1 or 2) or to any other example, further comprising that the processor circuitry is to execute the machine-readable instructions to present the output of the LLM to a user, obtain a refined prompt or follow-up prompt after presenting the output of the LLM to the user, provide at least the refined prompt or follow-up prompt as input to the LLM, obtain a further output of the LLM, and provide the code for implementing the additional component based on the further output of the LLM.

Another example (e.g., example 4) relates to a previous example (e.g., example 3) or to any other example, further comprising that the processor circuitry is to execute the machine-readable instructions to iteratively repeat the operations of presenting the output of the LLM to the user, obtaining the refined prompt or follow-up prompt, providing at least the refined prompt or follow-up prompt as input to the LLM, obtaining the further output of the LLM, and providing the code for implementing the additional component based on the further output of the LLM.

Another example (e.g., example 5) relates to a previous example (e.g., one of the examples 1 to 4) or to any other example, further comprising that the information on the existing application architecture is provided as context for the LLM.

Another example (e.g., example 6) relates to a previous example (e.g., one of the examples 1 to 5) or to any other example, further comprising that the information on the existing application architecture comprises metadata on the components of the existing application architecture.

Another example (e.g., example 7) relates to a previous example (e.g., one of the examples 1 to 6) or to any other example, further comprising that the information on the existing application architecture comprises, for the respective components of the existing application architecture, at least one of information of a functionality of the component, information on a usage of the component, information on a security of the component, information on an authentication scheme used by the component, information on a programming language being used to implement the component, information on one or more programming frameworks being used to implement the component, information on one or more libraries being used by the component, information on a use of one or more external Application Programming Interfaces by the component, information on an error handling of the component, information on a scalability of the component, information on a testability of the component, information on a user experience provided by the component, information on a data management of the component, information on an internationalization or localization of the component, information on a version control system being used for the component, information on a support for concurrency by the component, information on a code quality requirement supported by the component, and information on a name of the component.

Another example (e.g., example 8) relates to a previous example (e.g., one of the examples 1 to 7) or to any other example, further comprising that the information on the existing application architecture comprises information on one or more external Application Programming Interfaces being available for use by the modular application.

Another example (e.g., example 9) relates to a previous example (e.g., one of the examples 1 to 8) or to any other example, further comprising that the processor circuitry is to execute the machine-readable instructions to scan a code repository to generate at least a portion of the information on the existing application architecture.

Another example (e.g., example 10) relates to a previous example (e.g., example 9) or to any other example, further comprising that the processor circuitry is to execute the machine-readable instructions to generate at least a portion of the information on the existing application architecture based on a documentation of the existing application architecture being stored in the code repository.

Another example (e.g., example 11) relates to a previous example (e.g., one of the examples 1 to 10) or to any other example, further comprising that the processor circuitry is to execute the machine-readable instructions to generate at least a portion of the information on the existing application architecture based on a data layer of the existing application architecture.

Another example (e.g., example 12) relates to a previous example (e.g., one of the examples 1 to 11) or to any other example, further comprising that the processor circuitry is to execute the machine-readable instructions to generate at least a portion of the information on the existing application architecture using a Retrieval-Augmented Generation machine-learning model.

Another example (e.g., example 13) relates to a previous example (e.g., one of the examples 1 to 12) or to any other example, further comprising that the processor circuitry is to execute the machine-readable instructions to select, based on the prompt of the user, a subset of the information on the existing application architecture, and to provide the subset of the information on the existing application architecture as input for the LLM.

Another example (e.g., example 14) relates to a previous example (e.g., one of the examples 1 to 13) or to any other example, further comprising that the LLM is a text-generation LLM capable of generating code or a code-generation LLM.

Another example (e.g., example 15) relates to a previous example (e.g., one of the examples 1 to 14) or to any other example, further comprising that the information on the existing application architecture and the prompt are provided as input to the LLM via an Application Programming Interface of an external service for accessing the LLM.

An example (e.g., example 16) relates to an apparatus (10) for providing code, the apparatus comprising processor circuitry (14) configured to obtain information on an existing application architecture of a modular application, the information on the existing application architecture comprising, for components of the existing architecture, a formal description of the functionality and usage of the component of the existing architecture, obtain a prompt of a user for generating code for implementing an additional component for the modular application, the prompt comprising a textual description of a desired functionality of the additional component, provide the information on the existing application architecture and the prompt as input for a Large Language Model (LLM), obtain an output of the LLM, the output comprising a portion of the code for implementing the additional component, and provide the code for implementing the additional component based on the output of the LLM.

An example (e.g., example 17) relates to a device (10) for providing code, the device comprising means for processing (14) for obtaining information on an existing application architecture of a modular application, the information on the existing application architecture comprising, for components of the existing architecture, a formal description of the functionality and usage of the component of the existing architecture, obtaining a prompt of a user for generating code for implementing an additional component for the modular application, the prompt comprising a textual description of a desired functionality of the additional component, providing the information on the existing application architecture and the prompt as input for a Large Language Model (LLM), obtaining an output of the LLM, the output comprising a portion of the code for implementing the additional component, and providing the code for implementing the additional component based on the output of the LLM.

Another example (e.g., example 18) relates to a computer system (100) comprising the apparatus (10) or device (10) according to one of the examples 1 to 17.

An example (e.g., example 19) relates to a method for providing code, the method comprising obtaining (110) information on an existing application architecture of a modular application, the information on the existing application architecture comprising, for components of the existing architecture, a formal description of the functionality and usage of the component of the existing architecture, obtaining (120) a prompt of a user for generating code for implementing an additional component for the modular application, the prompt comprising a textual description of a desired functionality of the additional component, providing (140) the information on the existing application architecture and the prompt as input for a Large Language Model (LLM), obtaining (150) an output of the LLM, the output comprising a portion of the code for implementing the additional component, and providing (160) the code for implementing the additional component based on the output of the LLM.

Another example (e.g., example 20) relates to a previous example (e.g., one of the examples 19 or 20) or to any other example, further comprising that the method comprises presenting (160) the output of the LLM to a user, obtaining (120) a refined prompt or follow-up prompt after presenting the output of the LLM to the user, providing (140) at least the refined prompt or follow-up prompt as input to the LLM, obtaining (150) a further output of the LLM, and providing (160) the code for implementing the additional component based on the further output of the LLM.

Another example (e.g., example 21) relates to a previous example (e.g., example 20) or to any other example, further comprising that the method comprises iteratively repeating the operations of presenting (160) the output of the LLM to the user, obtaining (120) the refined prompt or follow-up prompt, providing (140) at least the refined prompt or follow-up prompt as input to the LLM, obtaining (150) the further output of the LLM, and providing (170) the code for implementing the additional component based on the further output of the LLM.

Another example (e.g., example 22) relates to a previous example (e.g., one of the examples 19 to 21) or to any other example, further comprising that the method comprises scanning a code repository to generate (112) at least a portion of the information on the existing application architecture.

Another example (e.g., example 23) relates to a previous example (e.g., example 22) or to any other example, further comprising that the method comprises generating (114) at least a portion of the information on the existing application architecture based on a documentation of the existing application architecture being stored in the code repository.

Another example (e.g., example 24) relates to a previous example (e.g., one of the examples 19 to 23) or to any other example, further comprising that the method comprises generating (116) at least a portion of the information on the existing application architecture based on a data layer of the existing application architecture.

Another example (e.g., example 25) relates to a previous example (e.g., one of the examples 19 to 24) or to any other example, further comprising that the method comprises generating (118) at least a portion of the information on the existing application architecture using a Retrieval-Augmented Generation machine-learning model.

Another example (e.g., example 26) relates to a previous example (e.g., one of the examples 19 to 25) or to any other example, further comprising that the method comprises selecting (130), based on the prompt of the user, a subset of the information on the existing application architecture, and providing (140) the subset of the information on the existing application architecture as input for the LLM.

Another example (e.g., example 27) relates to a computer system (100) configured to perform the method according to one of the examples 19 to 26.

Another example (e.g., example 28) relates to a non-transitory, computer-readable medium comprising a program code that, when the program code is executed on a processor, a computer, or a programmable hardware component, causes the processor, computer, or programmable hardware component to perform the method of one of the examples 19 to 26.

Another example (e.g., example 29) relates to a non-transitory machine-readable storage medium including program code, when executed, to cause a machine to perform the method of one of the examples 19 to 26.

Another example (e.g., example 30) relates to a computer program having a program code for performing the method of one of the examples 19 to 26, when the computer program is executed on a computer, a processor, or a programmable hardware component.

Another example (e.g., example 31) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means.

Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for providing code, the apparatus comprising interface circuitry, machine-readable instructions, and processor circuitry to execute the machine-readable instructions to:
obtain information on an existing application architecture of a modular application, the information on the existing application architecture comprising, for components of the existing architecture, a formal description of the functionality and usage of the component of the existing architecture;
obtain a prompt of a user for generating code for implementing an additional component for the modular application, the prompt comprising a textual description of a desired functionality of the additional component;
provide the information on the existing application architecture and the prompt as input for a Large Language Model (LLM);
obtain an output of the LLM, the output comprising a portion of the code for implementing the additional component; and
provide the code for implementing the additional component based on the output of the LLM.

2. The apparatus according to claim 1, wherein the additional component is an Application Programming Interface (API) being provided as part of the modular application.

3. The apparatus according to claim 1, wherein the processor circuitry is to execute the machine-readable instructions to present the output of the LLM to a user, obtain a refined prompt or follow-up prompt after presenting the output of the LLM to the user, provide at least the refined prompt or follow-up prompt as input to the LLM, obtain a further output of the LLM, and provide the code for implementing the additional component based on the further output of the LLM.

4. The apparatus according to claim 3, wherein the processor circuitry is to execute the machine-readable instructions to iteratively repeat the operations of presenting the output of the LLM to the user, obtaining the refined prompt or follow-up prompt, providing at least the refined prompt or follow-up prompt as input to the LLM, obtaining the further output of the LLM, and providing the code for implementing the additional component based on the further output of the LLM.

5. The apparatus according to claim 1, wherein the information on the existing application architecture is provided as context for the LLM.

6. The apparatus according to claim 1, wherein the information on the existing application architecture comprises metadata on the components of the existing application architecture.

7. The apparatus according to claim 1, wherein the information on the existing application architecture comprises, for the respective components of the existing application architecture, at least one of information of a functionality of the component, information on a usage of the component, information on a security of the component, information on an authentication scheme used by the component, information on a programming language being used to implement the component, information on one or more programming frameworks being used to implement the component, information on one or more libraries being used by the component, information on a use of one or more external Application Programming Interfaces by the component, information on an error handling of the component, information on a scalability of the component, information on a testability of the component, information on a user experience provided by the component, information on a data management of the component, information on an internationalization or localization of the component, information on a version control system being used for the component, information on a support for concurrency by the component, information on a code quality requirement supported by the component, and information on a name of the component.

8. The apparatus according to claim 1, wherein the information on the existing application architecture comprises information on one or more external Application Programming Interfaces being available for use by the modular application.

9. The apparatus according to claim 1, wherein the processor circuitry is to execute the machine-readable instructions to scan a code repository to generate at least a portion of the information on the existing application architecture.

10. The apparatus according to claim 9, wherein the processor circuitry is to execute the machine-readable instructions to generate at least a portion of the information on the existing application architecture based on a documentation of the existing application architecture being stored in the code repository.

11. The apparatus according to claim 1, wherein the processor circuitry is to execute the machine-readable instructions to generate at least a portion of the information on the existing application architecture based on a data layer of the existing application architecture.

12. The apparatus according to claim 1, wherein the processor circuitry is to execute the machine-readable instructions to generate at least a portion of the information on the existing application architecture using a Retrieval-Augmented Generation machine-learning model.

13. The apparatus according to claim 1, wherein the processor circuitry is to execute the machine-readable instructions to select, based on the prompt of the user, a subset of the information on the existing application architecture, and to provide the subset of the information on the existing application architecture as input for the LLM.

14. The apparatus according to claim 1, wherein the LLM is a text-generation LLM capable of generating code or a code-generation LLM.

15. The apparatus according to claim 1, wherein the information on the existing application architecture and the prompt are provided as input to the LLM via an Application Programming Interface of an external service for accessing the LLM.

16. A method for providing code, the method comprising:
obtaining information on an existing application architecture of a modular application, the information on the existing application architecture comprising, for components of the existing architecture, a formal description of the functionality and usage of the component of the existing architecture;
obtaining a prompt of a user for generating code for implementing an additional component for the modular application, the prompt comprising a textual description of a desired functionality of the additional component;
providing the information on the existing application architecture and the prompt as input for a Large Language Model (LLM);
obtaining an output of the LLM, the output comprising a portion of the code for implementing the additional component; and
providing the code for implementing the additional component based on the output of the LLM.

17. A non-transitory, computer-readable medium comprising a program code that, when the program code is executed on a processor, a computer, or a programmable hardware component, causes the processor, computer, or programmable hardware component to perform the method of claim 16.
